(19) United States
(12) Patent Application Publication
(10) Pub. No.: US 2022/0055550 A1
(43) Pub. Date: Feb. 24, 2022

(54) WIRE HARNESS

(71) Applicant: Yazaki Corporation, Tokyo (JP)

(72) Inventors: Hiroyuki TANAKA, Kakegawa-shi (JP); Yukihiro KAWAMURA, Makinohara-shi (JP)

(73) Assignee: Yazaki Corporation, Tokyo (JP)

(21) Appl. No.: 17/392,398

(22) Filed: Aug. 3, 2021

(30) Foreign Application Priority Data
Aug. 19, 2020 (JP) 2020-138728

(51) Int. Cl. B60R 16/02; H02G 3/04

(52) U.S. Cl. CPC B60R 16/0207; H02G 3/0406

(57) ABSTRACT

A wire harness is arranged in a routing path of a vehicle, and has a first electric wire and a second electric wire connected to the first electric wire. The first electric wire has a first conductor made of a single core conductor, and the second electric wire has a second conductor made of a stranded wire. The first electric wire has at least one bent portion in the routing path. The first electric wire is connected to both sides of the second electric wire, and is arranged under a floor constituting a passenger compartment of a vehicle body in the vehicle.

### TECHNICAL FIELD

The present invention relates to a wire harness.

### BACKGROUND ART

A wide variety of electronic devices are mounted on automobiles, and wire harnesses are arranged to transmit electric power, control signals, and the like to the electronic devices. This wire harness is laid out in a routing path between high-voltage devices mounted on, for example, a hybrid vehicle or an electric vehicle, and is used to electrically connect these high-voltage devices (For example, see Patent Document 1 and 2.).

In Patent Document 1, it is disclosed a wire harness configured to include a high-voltage conductive path and an exterior member that accommodates and protects the high-voltage conductive path. The exterior member has a low-rigidity portion and a high-rigidity portion configured to have higher rigidity than the low-rigidity portion, and the high-rigidity portion is configured to be arranged under the floor of the vehicle on the route.

The wire harness disclosed in Patent Document 2 includes a high-voltage electric wire, a low-voltage electric wire, and a corrugated tube as a tubular exterior member covering the high-voltage electric wire and the low-voltage electric wire, and is configured by wrapping an overall water-curable tape over substantially the entire length of the corrugated tube. In this wire harness, the part (bent part) of the routing path that is bent and assembled at a predetermined position of the vehicle is further wrapped with water-curable tape for the water-curable part to form a double structure, and form the bent part.

### PRIOR ART DOCUMENT

### Patent Document

Patent Document 1: JP 2014-220880 A

Patent Document 2: JP 2012-174666 A

### SUMMARY OF THE INVENTION

### Technical Problem

However, in the conventional wire harness disclosed in Patent Document 1, the wire harness is arranged so that the highly rigid portion of the exterior member is located at the portion where rigidity is required in the routing path. Here, the high-rigidity portion of the exterior member is preformed according to a different route for each vehicle type, and the wire harness is held on the route. For this reason, the exterior member cannot be used as a common part applicable to all vehicle models, resulting in poor versatility. In Patent Document 2, it is disclosed a technique of wrapping a tape around the outer periphery of a corrugated tube to form a double structure in place of a high-rigidity portion of an exterior member in a portion where rigidity is required in the routing path. However, it takes time and effort to wind the tape, and the wire harness itself may become large. That is, it was difficult to achieve both restraining the increase in size and providing versatility.

The present invention provides a wire harness with improved versatility while suppressing an increase in size.

### Solution to Problem

In order to solve the above problems, according to a first aspect of the present invention, there is provided a wire harness arranged in a vehicle's routing path including:
a first electric wire; and
a second electric wire connected to the first electric wire,
wherein the first electric wire has a first conductor made of a single-core conductor, and the second electric wire has a second conductor made of a stranded wire,
wherein the first electric wire has at least one bent portion in the routing path, and
wherein the second electric wire is connected to both sides of the first electric wire, and the first electric wire is arranged under a floor constituting a passenger compartment of a vehicle body in the vehicle.

According to a second aspect of the present invention, there is provided the wire harness of the first aspect,
wherein at a joint portion between the first electric wire and the second electric wire, tips of the first conductor and the second conductor are abutted and connected to each other.

According to a third aspect of the present invention, there is provided the wire harness of the first or second aspect equipped with an insulating tube,
wherein the first electric wire has a first insulator that covers the first conductor, and a first exposed portion that exposes the first conductor from the first insulator,
wherein the second electric wire has a second insulator that covers the second conductor, and a second exposed portion that exposes the second conductor from the second insulator, and
wherein tips of the first exposed portion and the second exposed portion are electrically connected to each other, and the first exposed portion and the second exposed portion are covered with the insulating tube.

According to a fourth aspect of the present invention, there is provided the wire harness of the third aspect,
wherein the insulating tube is formed so as to extend to the first insulator and the second insulator while covering the first exposed portion and the second exposed portion.

According to a fifth aspect of the present invention, there is provided the wire harness of any one of the first to fourth aspects,
wherein a plurality of the first electric wires is provided side by side, and the wire harness is provided with a tubular exterior member for accommodating the plurality of first electric wires, and
wherein in the exterior member, at least a part of a portion of the vehicle that is arranged under the floor constituting the passenger compartment of the vehicle body is formed in a flat shape.

### Effect of the Invention

According to the first aspect of the present invention, a wire harness routed to a vehicle's routing path includes:
a first electric wire; and
a second electric wire connected to the first electric wire,
wherein the first electric wire has a first conductor made of a single-core conductor, and the second electric wire has a second conductor made of a stranded wire,
wherein the first electric wire has at least one bent portion in the routing path, and the first electric wire has at least one bent portion, and wherein the second electric wire is connected to both sides of the first electric wire, and the first electric wire is arranged under a floor constituting a passenger compartment of a vehicle body in the vehicle. According to this, the first electric wire can be formed into a desired shape due to the rigidity of the single-core conductor. Therefore, the path is maintained on the route without the need for a high-rigidity portion for maintaining the route or tape winding for maintaining the route as in the prior art. As a result, it is possible to improve versatility while suppressing the increase in size of the wire harness.

At the same time, due to the rigidity of the single-core conductor, the first electric wire is maintained on the routing path, and the first electric wire can be arranged in a state of being separated from the ground without hanging.

### BRIEF DESCRIPTION OF DRAWINGS

FIG. 1 is a schematic view showing a state in which a wire harness according to an embodiment of the present invention is arranged in a routing path of a vehicle;

FIG. 2 is a perspective view showing a state in which the wire harness is arranged in the routing path of the vehicle;

FIG. 3 is a cross-sectional view showing the wire harness; and

FIG. 4 is a cross-sectional view showing a joint portion of a first electric wire and a second electric wire constituting the wire harness.

### DESCRIPTION OF EMBODIMENTS

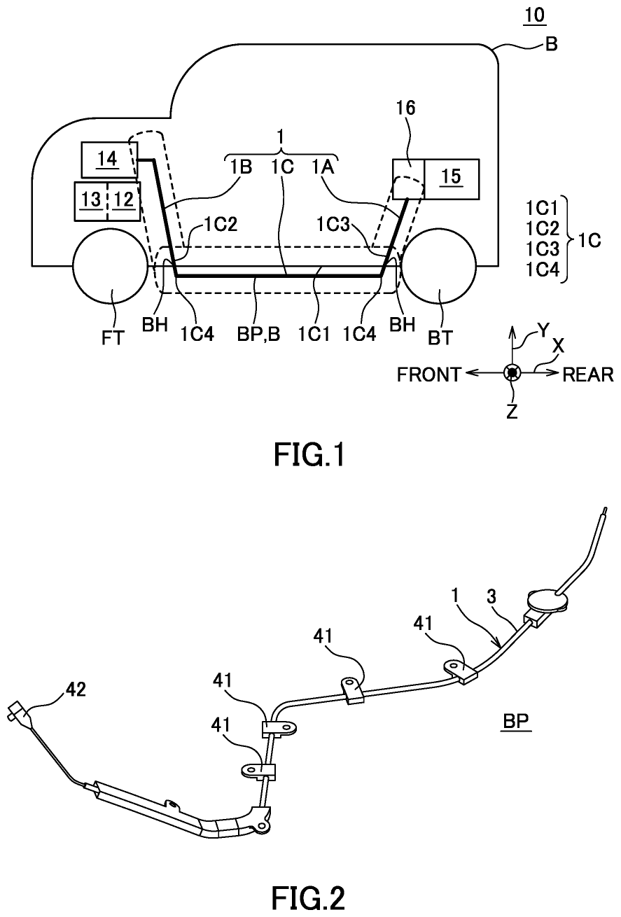

Hereinafter, an embodiment of the present invention will be described with reference to FIGS. 1 to 4. FIG. 1 is a schematic view showing a state in which the wire harness 1 according to the embodiment of the present invention is arranged in a routing path of a vehicle B. As shown in FIG. 1, the wire harness 1 of the present embodiment is adopted in a hybrid vehicle 10 (which may be an electric vehicle).

As shown in FIG. 1, the hybrid vehicle 10 is a vehicle B driven by using two powers of an engine 12 and a motor unit 13. Electric power from the battery 15 (battery pack) is supplied to the motor unit 13 via an inverter unit 14.

In this embodiment, the engine 12, the motor unit 13, and the inverter unit 14 are mounted on the front portion of the vehicle B having the front wheel FT and the like, and the battery 15 is mounted on the rear portion of the vehicle B having the rear wheel BT and the like. The motor unit 13 includes a motor and a generator in its configuration, and is covered with a shield case to form a motor assembly. The inverter unit 14 includes an inverter and a converter in the configuration, and is covered with a shield case to form an inverter assembly.

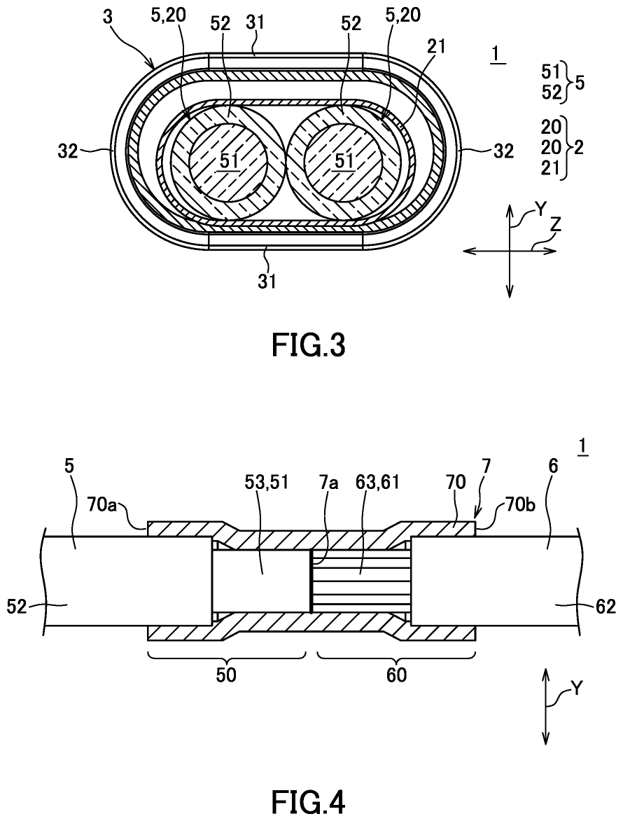

Further, the motor unit 13 and the battery 15 are connected via the wire harness 1. As shown in FIGS. 2 and 3, the wire harness 1 is configured to include a high-voltage conductive path 2 (shown in FIG. 3), a flat exterior member 3 accommodating the high-voltage conductive path 2, a not-shown shield connector 42 provided at the terminal of the high-voltage conductive path 2, a clamp 41 (shown in FIG. 2) attached to the outer surface of the exterior member 3 for fixing the high-voltage conductive path 2 to the vehicle body panel BP, and a grommet (not shown) attached to a through hole BH of the vehicle body panel BP or the like. Incidentally, the wire harness 1 may be configured such that a low-voltage conductive path is accommodated in the exterior member 3 as well as the high-voltage conductive path 2.

As shown in FIG. 3, the high-voltage conductive path 2 includes a pair of high-voltage power lines 20, 20 and a shield member 21 that collectively covers the pair of high-voltage power lines 20, 20. In this embodiment, the high-voltage conductive path 2 includes the pair of high-voltage power lines 20, 20, and the shield member 21. However, a sheath (not shown), which is an outer coating body that protects the high-voltage power lines 20, 20, may be provided on the outside of the shield member 21 and inside the exterior member 3.

In the present embodiment, a direction in which the pair of high-voltage wires 20, 20 are lined up (denoted as a left-right direction) is indicated by an arrow Z, and a direction orthogonal to (crossing) the arrow Z (denoted as a vertical direction) is indicated by an arrow Y, and a direction orthogonal to both directions of the arrow Y and the arrow Z (denoted as a front-back direction) is indicated by an arrow X. The arrow X is a traveling direction of the vehicle B, and the front wheel FT side may be described as “front” and the rear wheel BT side may be described as “rear”.

As shown in FIG. 4, each of the high-voltage power lines 20, 20 includes a first electric wire 5, a second electric wire 6 connected to the first electric wire 5, and a joint portion 7 to which the first electric wire 5 and the second electric wire 6 are connected.

As shown in FIG. 3, the first electric wire 5 includes a first conductor 51 and a first insulator 52 that covers the first conductor 51. The first conductor 51 is a rod-shaped single-core conductor composed of copper, a copper alloy, or a conductive metal such as aluminum or the same alloy of aluminum. In the present embodiment, the first conductor 51 has a circular cross section (may be a rectangular cross section). The first conductor may be composed of a flat conductor such as a bass bar. The first conductor 51 is configured to have a rigidity sufficient to maintain a routing shape. That is, the first conductor 51 is formed by mixing one or a plurality of metals so as to have a rigidity sufficient to maintain the routing shape. Further, the rigidity of the first conductor 51 is configured to be higher than the rigidity of the second conductor 61 described later of the second electric wire 6. The first insulator 52 is formed by extruding an insulating resin material around the outer periphery of the first conductor 51. As shown in FIG. 4, in the first electric wire 5, by peeling off the first insulator 52 at the terminal portion 50 of the first electric wire 5, the first conductor 51 is exposed (referred to as the first exposed portion 53).

As shown in FIG. 4, the second electric wire 6 includes a second conductor 61 and a second insulator 62 that covers the second conductor 61. The second conductor 61 is made of a conductive metal and is composed of a stranded wire which is an aggregate of linear strands. The second insulator 62 is formed by extruding an insulating resin material around the outer periphery of the second conductor 61. In the second electric wire 6, the second insulator 62 is peeled off at the terminal portion 60 of the second electric wire 6, and a part of the second conductor 61 (referred to as the second exposed portion 63) is exposed.

As shown in FIG. 4, the joint portion 7 includes a terminal portion 50 of the first electric wire 5, a terminal portion 60 of the second electric wire 6, and a shrinkage tube 70 (insulating tube) covering each of the terminal portions 50, 60 of the first electric wire 5 and the second electric wire 6.

As shown in FIG. 4, one end surface of the second conductor 61 abuts on the other end surface of the first conductor 51, and the second conductor 61 is electrically connected (abutted and connected) to the first conductor 51. “Abutted and connected” is a state in which the end surface of the second conductor 61 is pressed against the end surface of the first conductor 51 and the first conductor 51 and the second conductor 61 are electrically connected. An electrical connection portion 7a of the first conductor 51 and the second conductor 61 may be weld-bonded so that the electrical connection state of the first conductor 51 and the second conductor 61 is maintained.

As shown in FIG. 4, the shrinkage tube 70 is a flexible tubular member, and is formed of, for example, an insulating resin material. The shrinkage tube 70 is formed so as to be freely curved at an arbitrary position. The shrinkage tube 70 is composed of a heat-shrinkable tube configured to contract when heated and to solidify in a contracted state. Such a shrinkage tube 70 covers the first exposed portion 53 and the second exposed portion 63 in a state where the shrink tube 70 is positioned in a predetermined position, heated, and shrunk. At the same time, one end 70a covers the terminal portion of the first insulator 52, and the other end 70b covers the terminal portion of the second insulator 62. That is, the shrinkage tube 70 is formed so as to extend to the first insulator 52 and the second insulator 62 while covering the first exposed portion 53 and the second exposed portion 63.

As shown in FIG. 3, the shield member 21 is formed by weaving conductive strands into a tubular shape and a mesh shape. The shield member 21 suppresses that electromagnetic noise generated by the flow of an electric current through the first conductor 51 and the second conductor 61 affects the electronic devices and the like arranged around the high-voltage power lines 20, 20. At the same time, the influence of electromagnetic noise from the surroundings on the first conductor 51 and the second conductor 61 is suppressed. Further, in the present embodiment, the shield member 21 collectively covers the pair of high-voltage power lines 20, 20, but the present invention is not limited thereto. The shield member 21 may be configured to cover each of the high-voltage power lines 20, 20. That is, each of the high-voltage electric wires 20, 20 may be composed of known shielded electric wires.

As shown in FIGS. 2 and 3, the exterior member 3 is made of an insulating resin material and is made of a tubular corrugated tube capable of covering the high-voltage conductive path 2. The exterior member 3 is configured to have a length that can be arranged at least under the floor of the vehicle B (under the floor of a portion constituting the passenger compartment of the vehicle body).

As shown in FIG. 3, in the exterior member 3, the portion of the exterior member 3 to be arranged under the floor of the vehicle B has a truck-shaped cross section, and formed by a pair of horizontal wall portions 31, 31 facing in the vertical direction (arrow Y) and a pair of semicircular arc-shaped wall portions 32, 32 that face each other in the left-right direction (arrow Z) and are continuous with the pair of horizontal wall portions 31, 31. Further, in the exterior member 3, the cross section of the portion of the vehicle B to be arranged under the floor is formed to be flat such that the dimension in the vertical direction (arrow Y) between the pair of horizontal wall portions 31, 31 is smaller than the maximum dimension in the horizontal direction Z between the pair of arc-shaped wall portions 32, 32. Alternatively, in the exterior member 3, at least a part of the portion to be arranged under the floor of the vehicle B may be formed in a flat shape.

The exterior member 3 is fixed to the vehicle body panel BP with the pair of horizontal wall portions 31, 31 facing in the vertical direction (arrow Y) in a state where the high-voltage conductive path 2 is inserted. According to this, in the exterior member 3, the portion laid out under the floor of the vehicle B is made shorter than the case where the exterior member having a circular cross section is laid out. In addition, in the exterior member 3, if the portion to be arranged under the floor of the vehicle B is formed so that the dimension in the vertical direction (arrow Y) is smaller than the dimension in the horizontal direction (arrow Z), the cross section may be substantially rectangular, elliptical, or slot-shaped. Further, when the exterior member 3 is arranged in a place other than under the floor of the vehicle B, another exterior member may be used to connect the exterior member 3 with a connecting member (not shown). In this case, the exterior member 3 may have the above-mentioned shape or may have a circular cross section, and the exterior members 3 having different shapes may be appropriately connected and used.

As shown in FIG. 1, the wire harness 1 includes a battery-side wiring unit 1A connected to the battery 15, a motor-side wiring unit 1B connected to the motor unit 13, and an intermediate wiring unit 1C located between the battery-side wiring unit 1A and the motor-side wiring unit 1B.

As shown in FIGS. 1 and 2, a shield connector 42 (shown in FIG. 2) is attached to the terminal portion of the high-voltage conductive path 2 in the battery-side wiring unit 1A. When the shield connector 42 connected to a connector (not shown) of the junction box 16, the battery-side wiring unit 1A is connected to the battery 15 via the junction box 16. In the battery-side wiring unit 1A, the pair of high-voltage electric wires 20, 20 constituting the high-voltage conductive path 2 are each composed of the second electric wire 6. That is, the battery-side wiring unit 1A is configured to have flexibility because it includes a second conductor 61 made of a stranded wire.

As shown in FIGS. 1 and 2, a shield connector 42 (shown in FIG. 2) is attached to the terminal portion of the high-voltage conductive path 2 in the motor-side wiring unit 1B. When the shield connector 42 is connected to a connector (not shown) of the inverter unit 14, the motor-side wiring unit 1B is connected to the motor unit 13 via the inverter unit 14. In the motor-side wiring unit 1B, the pair of high-voltage electric wires 20, 20 constituting the high-voltage conductive path 2 are each composed of the second electric wire 6. That is, the motor-side wiring unit 1B is configured to have flexibility because it includes a second conductor 61 made of a stranded wire.

As shown in FIG. 1, the intermediate wiring unit 1C penetrates the vehicle body panel BP and is arranged under the floor of the vehicle B. The intermediate wiring unit 1C includes a straight portion 1C1 arranged under the floor of the vehicle B, a bent portion 1C4, a front side rising portion 1C2 that continuously penetrates the bent portion 1C4 and penetrates the vehicle body panel BP, the bent portion 1C4, and a rear side rising portion 1C3 that continuously penetrates the vehicle body panel BP and the bent portion 1C4, and is formed in a substantially U shape. That is, in the intermediate wiring unit 1C, the front side rising portion 1C2 and the rear side rising portion 1C3 are continuously provided at both ends of the straight portion 1C1 via the bent portions 1C4. In the intermediate wiring unit 1C, the pair of high-voltage electric wires 20, 20 constituting the high-voltage conductive path 2 are each composed of the first electric wire 5 and are provided side by side in the left-right direction (arrow Z). That is, since the intermediate wiring portion 1C is configured to include the first conductor 51 made of a single-core conductor, it is configured to have a rigidity sufficient to maintain the wiring arrangement shape.

Such a wire harness 1 is assembled by the following procedure. First, the high-voltage conductive path 2 is inserted through the exterior member 3 to obtain the battery-side wiring unit 1A, the motor-side wiring unit 1B, and the intermediate wiring unit 1C. Here, in the battery-side wiring unit 1A and the motor-side wiring unit 1B, the pair of high-voltage electric wires 20, 20 constituting the high-voltage conductive path 2 are each composed of the second electric wire 6, and in the intermediate wiring unit 1C, the pair of high-voltage electric wires 20, 20 constituting the high-voltage conductive path 2 are each composed of the first electric wire 5. That is, the second electric wires 6 are connected to both sides of the first electric wire 5. Further, the intermediate wiring unit 1C is pre-formed so that the straight portion 1C1, the front side rising portion 1C2, and the rear side rising portion 1C3 are formed. Next, clamps 41 and grommets are attached at appropriate positions of the battery-side wiring unit 1A, the motor-side wiring unit 1B, and the intermediate wiring unit 1C. Further, a shield connector 42 is attached to the terminal portion of the high-voltage conductive path 2 in the battery-side wiring unit 1A and the motor-side wiring unit 1B. In this way, the wire harness 1 is completed.

Next, a procedure for allocating the wire harness 1 to the routing path of the vehicle B will be described with reference to FIG. 1. As shown in FIG. 1, first, a grommet is attached to the through hole BH of the vehicle body panel BP in advance. The intermediate wiring unit 1C is brought close to the underfloor of the vehicle B, and the straight portion 1C1 is placed along the underfloor with the pair of horizontal wall portions 31 and 31 facing in the vertical direction (arrow Y). At the same time, the front side rising portion 1C2 and the rear side rising portion 1C3 are inserted into the through holes BH of the vehicle body panel BP via grommets, respectively. Next, an appropriate position of the intermediate wiring unit 1C is fixed to the vehicle body panel BP with the clamp 41. At this time, since the intermediate wiring portion 1C including the first electric wire 5 made of a single-core conductor is arranged in the portion to be arranged under the floor of the vehicle B, the wire harness 1 is in a state of suppressing bending, and can be attached to the body panel BP with good workability. After that, the shield connector 42 at the terminal of the battery-side wiring unit 1A is connected to the connector of the junction box 16. As a result, the terminal of the battery-side wiring unit 1A is connected to the battery 15 via the junction box 16. Further, the shield connector 42 at the terminal of the motor-side wiring unit 1B is connected to the connector of the inverter unit 14. As a result, the terminal of the motor-side wiring unit 1B is connected to the motor unit 13 via the inverter unit 14. In this way, the wire harness 1 is in a state of being arranged in a predetermined routing path, and power is supplied to the motor unit 13 from the battery 15 (battery pack).

According to the above-described embodiment, the first electric wire 5 has the first conductor 51 made of a single core conductor, the second electric wire 6 has the second conductor 61 made of a stranded wire, and the first electric wire 5 has at least one bent portion 1C4 in the routing path. The second electric wires 6 are connected to both sides of the first electric wire 5, and the first electric wire 5 is arranged under the floor constituting the passenger compartment of the vehicle body in the vehicle B. According to this, the first electric wire 5 can be formed into a desired shape due to the rigidity of the single-core conductor. Therefore, the route is maintained on the routing path without the need for a high-rigidity portion for maintaining the routing path or tape winding for maintaining the routing path as in the prior art. As a result, it is possible to improve versatility while suppressing the increase in size of the wire harness 1. At the same time, due to the rigidity of the single-core conductor, the first electric wire 5 is maintained on the routing path, and the first electric wire 5 can be arranged in a state of being separated from the ground without hanging.

Further, at the joint portion 7 of the first electric wire 5 and the second electric wire 6, the tips of the first conductor 51 and the second conductor 61 are abutted and connected to each other. According to this, the conductivity of the first conductor 51 and the second conductor 61 can be improved.

Further, an insulating shrinkage tube 70 (insulating tube) is provided, and the tips of the first exposed portion 53 and the second exposed portion 63 are electrically connected to each other, and covered with the shrinkage tube 70. According to this, the first exposed portion 53 and the second exposed portion 63 are covered with the shrinkable tube 70 to protect the first exposed portion 53 and the second exposed portion 63 while improving the insulating property.

Further, the shrinkage tube 70 (insulating tube) is formed so as to extend to the first insulator 52 and the second insulator 62 while covering the first exposed portion 53 and the second exposed portion 63. According to this, the mechanical connectivity of the joint portion 7 can be improved.

Further, a plurality of first electric wires 5 is provided side by side, and a tubular exterior member 3 for accommodating the plurality of first electric wires 5 is provided. In the exterior member 3, at least a part of the portion of the vehicle B that is arranged under the floor that constitutes the passenger compartment of the vehicle body is formed in a flat shape. According to this, in the exterior member 3, the portion laid out under the floor of the vehicle B is shorter than the case where the exterior member having a circular cross section is laid out.

The present invention is not limited to the above-described embodiment, but includes other configurations and the like that can achieve the object of the present invention, and the following modifications and the like are also included in the present invention.

In the above embodiment, in the wire harness 1, the intermediate wiring unit 1C is provided with the front side rising portion 1C2 and the rear side rising portion 1C3 continuously provided at both ends of the straight portion 1C1 via the bending portions 1C4. That is, the wire harness has two bent portions 1C4, but the present invention is not limited thereto. The wire harness may have at least one bent portion.

Further, in the above embodiment, in the wire harness 1, the battery-side wiring unit 1A and the motor-side wiring unit 1B are composed of the second electric wire 6. However, the present invention is not limited to this. For example, a portion of the battery-side wiring unit 1A and the motor-side wiring unit 1B that is linearly arranged while suppressing bending may be configured by the first electric wire 5.

Further, in the above embodiment, as shown in FIG. 4, one end surface of the second conductor 61 abuts on the other end surface of the first conductor 51, and the second conductor 61 is electrically connected (butted and connected) to the first conductor 51. However, the present invention is not limited to this. Although the joint portion 7 of the second conductor 61 is larger than that of the case where the second conductor 61 is electrically connected to the first conductor 51, the first conductor 51 and the second conductor 61 may be electrically connected to each other with their tips overlapping each other in the extending direction of the conductors 51 and 61. In this state, it may be covered with the shrinkage tube 70 (insulating tube).

Further, in the above embodiment, the shrinkable tube 70 (insulated tube) is composed of a heat-shrinkable tube configured to shrink when heated and to harden in the contracted state. However, the present invention is not limited to this. The insulating tube may be a butyl tube, or may be resin-molded so as to cover the first exposed portion 53 and the second exposed portion 63. That is, the insulating tube in the present invention is not limited to the shrinkage tube 70, and may be composed of any member as long as it covers and protects the first exposed portion 53 and the second exposed portion 63.

In addition, the best configuration, method, and the like for carrying out the present invention are disclosed in the above description, but the present invention is not limited thereto. That is, the present invention is particularly illustrated and described primarily with respect to specific embodiments. However, those skilled in the art can make various modifications to the above-described embodiments in terms of shape, material, quantity, and other detailed configurations without departing from the scope of the technical idea and purpose of the present invention. Therefore, the description that limits the shape, material, etc. disclosed above is merely an example description for facilitating the understanding of the present invention, and does not limit the present invention. Therefore, the description by the name of the member excluding some or all of the restrictions such as the shape and the material is included in the present invention.

### REFERENCE SIGNS LIST

1 Wire harness
3 Exterior member
5 first electric wire
51 First conductor
52 First insulator
53 first exposed part
6 Second electric wire
61 Second conductor
62 Second insulator
63 Second exposed part
7 Joint portion
70 Shrinkage tube (insulated tube)
1C4 Front end (bent part), rear end (bent part)
B vehicle

1. A wire harness arranged in a vehicle's routing path comprising:
a first electric wire; and
a second electric wire connected to the first electric wire,
wherein the first electric wire has a first conductor made of a single-core conductor, and the second electric wire has a second conductor made of a stranded wire,
wherein the first electric wire has at least one bent portion in the routing path, and
wherein the second electric wire is connected to both sides of the first electric wire, and the first electric wire is arranged under a floor constituting a passenger compartment of a vehicle body in the vehicle.

2. The wire harness as claimed in claim 1,
wherein at a joint portion between the first electric wire and the second electric wire, tips of the first conductor and the second conductor are abutted and connected to each other.

3. The wire harness as claimed in claim 1 further comprising: an insulating tube,
wherein the first electric wire has a first insulator that covers the first conductor, and a first exposed portion that exposes the first conductor from the first insulator,
wherein the second electric wire has a second insulator that covers the second conductor, and a second exposed portion that exposes the second conductor from the second insulator, and
wherein tips of the first exposed portion and the second exposed portion are electrically connected to each other, and the first exposed portion and the second exposed portion are covered with the insulating tube.

4. The wire harness as claimed in claim 3,
wherein the insulating tube is formed so as to extend to the first insulator and the second insulator while covering the first exposed portion and the second exposed portion.

5. The wire harness as claimed in claim 1,
wherein a plurality of the first electric wires is provided side by side, and the wire harness is provided with a tubular exterior member for accommodating the plurality of first electric wires, and
wherein in the exterior member, at least a part of a portion of the vehicle that is arranged under the floor constituting the passenger compartment of the vehicle body is formed in a flat shape.
